(19) United States
(12) Patent Application Publication
(10) Pub. No.: US 2025/0151164 A1
(43) Pub. Date: May 8, 2025

(54) WIRELESS COMMUNICATION METHODS FOR MULTICAST/BROADCAST SERVICE AND APPARATUSES

(71) Applicant: SHENZHEN TCL NEW TECHNOLOGY CO., LTD., Shenzhen, Guangdong (CN)

(72) Inventors: Xin ZHANG, Shenzhen, Guangdong (CN); Jia SHENG, Shenzhen, Guangdong (CN)

(73) Assignee: SHENZHEN TCL NEW TECHNOLOGY CO., LTD., Shenzhen, Guangdong (CN)

(21) Appl. No.: 18/838,217

(22) PCT Filed: Apr. 12, 2022
(86) PCT No.: PCT/CN2022/086355

§ 371 Date: Aug. 13, 2024

(51) Int. Cl. H04W 76/40; H04W 72/12; H04W 76/20; H04W 76/30

(52) U.S. Cl. CPC H04W 76/40; H04W 72/12; H04W 76/20; H04W 76/30

(57) ABSTRACT

Wireless communication methods for multicast/broadcast service (MBS) and apparatuses are disclosed. The method performed by a user equipment (UE) includes when the UE is interested in one or more multicast services/sessions or receives the one or more of multicast services/sessions, the UE is in a connected state or is indicated to enter the connected state, receiving, by the UE being in the connected state or being indicated to enter the connected state, a multicast configuration via a dedicated signaling, entering, by the UE, an inactive state when the UE receives the multicast configuration, and receiving, by the UE in the inactive state, the one or more of multicast services/sessions.

### BACKGROUND OF DISCLOSURE

### 1. Field of the Disclosure

The present disclosure relates to the field of wireless communication systems, and more particularly, to wireless communication methods for multicast/broadcast service (MBS) and apparatuses, for example, particularly to an MBS system.

### 2. Description of the Related Art

In a 3rd generation partnership project (3GPP) cellular network, broadcast and multicast services may be transported via a transport service called multimedia broadcast/multicast service (MBMS). A broadcast multicast service center (BM-SC) server is responsible to disseminate a media content to a group of subscribers. When a UE moves out of a network coverage, the UE may be unable to use the MBMS because uplink and downlink connections to the BM-SC server are no longer available. MBMS is a point-to-multipoint (PTM) interface specification designed to provide efficient delivery of broadcast and multicast services within 3GPP cellular networks. Examples of MBMS interface specifications include those described in universal mobile telecommunication system (UMTS) and long term evolution (LTE) communication specifications. For broadcast transmission across multiple cells, the specifications define transmission over single-frequency network configurations. Intended applications include mobile TV, news, radio broadcasting, file delivery, emergency alerts, and others. When services are broadcasted by MBMS, all cells inside a multimedia broadcast/multicast service single frequency network (MBSFN) area transmit the same MBMS service.

Users access these services and obtain the MBMS content through wireless communication devices such as cellular phones, tablets, laptops, and other devices with wireless transceivers that communicate with the base station within the communication system. The base station provides wireless service to the wireless communication devices, sometimes referred to as mobile devices or UEs, within cells. A user can access at least some multimedia services through a UE using either a point-to-point (PTP) connection or a PTM transmission. In 3GPP systems, PTP services can be provided using unicast techniques and PTM transmissions can be provided using MBMS communication, transmitted over an MBSFN or single cell point to multipoint (SC-PTM) communication. In systems operating in accordance with a revision of 3GPP long term evolution (LTE) communication specification, MBMS is provided using eMBMS. Accordingly, an MBMS service can be provided using either unicast service, MBSFN, or SC-PTM in an LTE system.

To enable resource-efficient delivery of multicast/broadcast services, 3GPP has developed NR broadcast/multicast in Rel-17 according to a work item (WID), aiming to enable general MBS services over 5GS. The use cases identified that could benefit from this feature include public safety and mission critical, V2X applications, IPTV, live video, software delivery over wireless and IoT applications, etc. Two delivery modes have been agreed for Rel-17 MBS with delivery mode 1 (only for multicast) capable of addressing higher QoS services and delivery mode 2 (only for broadcast) focusing on lower QoS services. Given that Rel-17 MBS already provide the basic function to support MBS services, the general main goal for Rel-18 should be to enable better deployment of MBS, such as improvement of resource efficiency and capacity based on Rel-17 MBS.

In Rel-17, RAN only specifies multicast for UEs in RRC_CONNECTED state, which may not fully fulfil the requirements of, e.g., mission critical services, especially for cells with a large number of UEs according to TR 23.774. Also, to always keep UEs in RRC_CONNECTED state is not power efficient. It is therefore important to support multicast for UEs in RRC_INACTIVE.

Therefore, there is a need for wireless communication methods for multicast/broadcast service (MBS) and apparatuses.

### SUMMARY

An object of the present disclosure is to propose wireless communication methods for multicast/broadcast service (MBS) and apparatuses.

In a first aspect of the present disclosure, a wireless communication method for multicast/broadcast service (MBS) performed by a user equipment (UE) includes when the UE is interested in one or more multicast services/sessions or receives the one or more of multicast services/sessions, the UE is in a connected state or is indicated to enter the connected state, receiving, by the UE being in the connected state or being indicated to enter the connected state, a multicast configuration via a dedicated signaling, entering, by the UE, an inactive state when the UE receives the multicast configuration, and receiving, by the UE in the inactive state, the one or more of multicast services/sessions.

In a second aspect of the present disclosure, a user equipment (UE) comprises a memory, a transceiver, and a processor coupled to the memory and the transceiver. The processor is configured to perform the above method.

In a third aspect of the present disclosure, a non-transitory machine-readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a flowchart illustrating an example of a wireless communication method for MBS.

FIG. 2 is a schematic diagram illustrating an example of downlink layer 2 architecture for multicast session according to an embodiment of the present disclosure.

FIG. 3 is a block diagram of one or more user equipments (UEs) and a base station (e.g., gNB) of communication in a communication network system according to an embodiment of the present disclosure.

FIG. 4 is a flowchart illustrating a wireless communication method for MBS performed by the UE according to an embodiment of the present disclosure.

FIG. 5 is a flowchart illustrating a wireless communication method for MBS according to an embodiment of the present disclosure.

FIG. 6 is a flowchart illustrating a wireless communication method for MBS according to an embodiment of the present disclosure.

FIG. 7 is a flowchart illustrating a wireless communication method for MBS according to an embodiment of the present disclosure.

FIG. 8 is a flowchart illustrating a wireless communication method for MBS according to an embodiment of the present disclosure.

FIG. 9 is a flowchart illustrating a wireless communication method for MBS according to an embodiment of the present disclosure.

FIG. 10 is a flowchart illustrating a wireless communication method for MBS according to an embodiment of the present disclosure.

FIG. 11 is a flowchart illustrating a wireless communication method for MBS according to an embodiment of the present disclosure.

FIG. 12 is a flowchart illustrating a wireless communication method for MBS according to an embodiment of the present disclosure.

FIG. 13 is a flowchart illustrating a wireless communication method for MBS according to an embodiment of the present disclosure.

FIG. 14 is a flowchart illustrating a wireless communication method for MBS according to an embodiment of the present disclosure.

FIG. 15 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In RANP#94 meeting, the following R18 WID has been approved. This work item is to further enhance the NR Multicast/Broadcast functions based on Rel-17 MBS. The objectives for Rel-18 include: 1. Specify support of multicast reception by UEs in RRC_INACTIVE state [RAN2, RAN3]. Specify PTM configuration for UEs receiving multicast in RRC_INACTIVE state [RAN2]. Study the impact of mobility and state transition for UEs receiving multicast in RRC_INACTIVE [RAN2, RAN3]. 2. Specify Uu signaling enhancements to allow a UE to use shared processing for MBS broadcast and unicast reception, i.e., including UE capability and related assistance information reporting regarding simultaneous unicast reception in RRC_CONNECTED and MBS broadcast reception from the same or different operators [RAN2]. 3. Study and if necessary, specify enhancements to improve the resource efficiency for MBS reception in RAN sharing scenarios [RAN3].

In some embodiments of the present disclosure, one or more of the following issues can be addressed. 1. Specify support of multicast reception by UEs in RRC_INACTIVE state [RAN2, RAN3]. 2. Specify PTM configuration for UEs receiving multicast in RRC_INACTIVE state [RAN2]. Therefore, in some embodiments of the present disclosure, multicast can be allowed to be received by UEs in an RRC connected mode and in an RRC inactive mode.

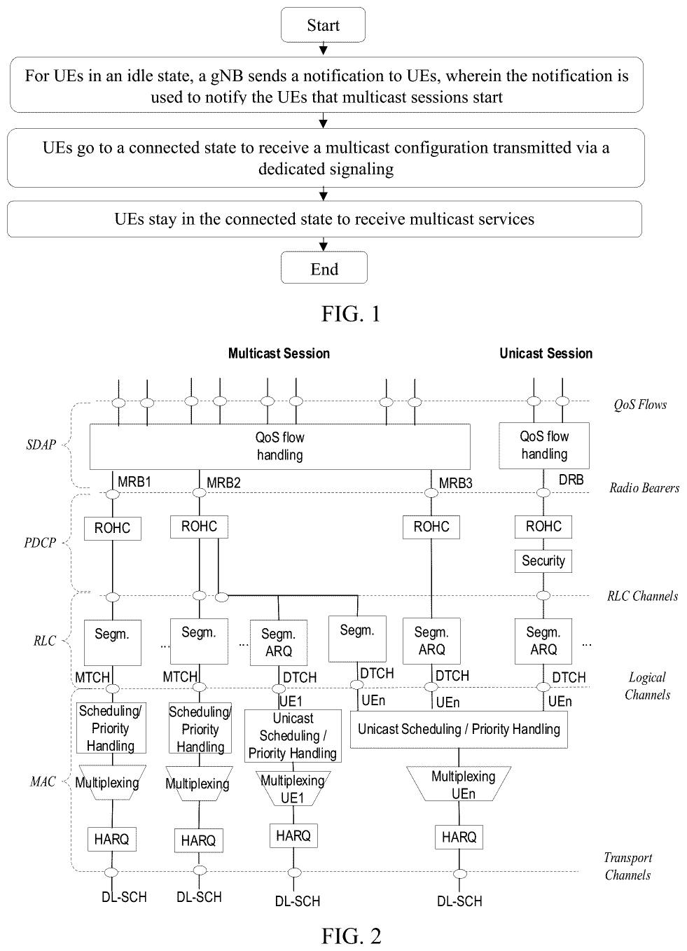

FIG. 1 is a flowchart illustrating an example of a wireless communication method for MBS. FIG. 1 illustrates that, in some embodiments, for UEs in an idle state, a gNB sends a notification to the UEs, wherein the notification is used to notify the UEs that multicast sessions start. Further, UEs go to a connected state to receive a multicast configuration transmitted via a dedicated signaling. Further, UEs receive the one or more multicast services in the connected state. In details, idle UEs receive the notification from the gNB that informs the UEs of a start of multicast sessions. After that, the idle UEs enter the connected state to accept the multicast configuration, and then accept the multicast services. In another example, the notification may be an MCCH change notification. The MCCH change notification is for UEs interested in broadcast. Therefore, the UEs are only interested in multicast and may not monitor the MCCH change notification. In another example, the notification can be a group notification. If UEs interested in multicast are in an idle/inactive state, the UEs can receive the group notification. The group notification can be a paging message. The paging message for the group notification contains an MBS session ID which is utilized to page all UEs in RRC IDLE and RRC INACTIVE states that joined the associated MBS multicast session.

Multicast/broadcast services (MBS) are expected to cover diversity of 5G applications and services ranging from public safety, mission critical, V2X, transparent IPv4/IPv6 multicast delivery, IPTV, software delivery over wireless to group communications and IoT applications. According to the MBS work in Rel-17, two delivery modes have been agreed for Rel-17 MBS with delivery mode 1 (only for multicast) capable of addressing higher QoS services, and delivery mode 2 (only for broadcast) focusing on lower QoS services. Due to the fact that multicast delivery mode is targeting almost the same RRC state (RRC CONNECTED) and the same range of QoS requirements, a flexible protocol architecture that allows for simultaneous operation with unicast session was specified for multicast session data delivery. The flexibility of the specified multicast protocol architecture relies on allowing simultaneous operation of multicast and unicast based on interaction between a UE and a gNB. The specified protocol architecture for multicast includes: 1) A service data adaptation protocol (SDAP) layer or entity responsible for mapping QoS flows of a multicast session to MBS Radio Bearers (MRB). 2) A dedicated packet data convergence protocol (PDCP) entity as well as a common PDCP entity linked to two radio link control (RLC) entities, one is a group-common point to multipoint (PTM) RLC and the other is a UE-dedicated point-to-point (PTP) RLC to allow gNB to send data packets via either PTP RLC, PTM RLC or both to a UE and allow switching between PTM RLC and PTP RLC whenever needed (i.e., based on interaction between UE and gNB). 3) A media access control (MAC) entity allows multicast MBS traffic channel (MTCH) to share a common logical channel identity (LCID) space with unicast dedicated traffic channel (DTCH). The above specified flexible protocol architecture for multicast can not only allow simultaneous operation of unicast and multicast but also it can help allow UE to use share some processing when receiving unicast and multicast simultaneously.

FIG. 2 is a schematic diagram illustrating an example of downlink layer 2 architecture for multicast session according to an embodiment of the present disclosure. FIG. 2 illustrates that, in some embodiments, an MBS protocol stack comprises layer 2 sublayers, wherein SDAP sublayer provides only the following functionalities: 1. Mapping between an MBS QoS flow and an MRB. 2. Transfer of user plane data. PDCP sublayer provides only the following functionalities: Transfer of data, maintenance of PDCP SNs, header compression and decompression using the ROHC protocol or EHC protocol, reordering and in-order delivery, and duplicate discarding. For a multicast session, gNB provides one or more of the following multicast MRB configuration(s) to the UE via dedicated RRC signaling: Multicast MRB with DL only RLC-UM or bidirectional RLC-UM configuration for PTP transmission, multicast MRB with RLC-AM entity configuration for PTP transmission, multicast MRB with DL only RLC-UM entity for PTM transmission, multicast MRB with two RLC-UM entities, one DL only RLC-UM entity for PTP transmission and the other DL only RLC-UM entity for PTM transmission, multicast MRB with three RLC-UM entities, one DL RLC-UM entity and one UL RLC-UM entity for PTP transmission and the other DL only RLC-UM entity for PTM transmission, multicast MRB with two RLC entities, one RLC-AM entity for PTP transmission and the other DL only RLC-UM entity for PTM transmission. For a multicast session, gNB may change the MRB type using RRC signaling.

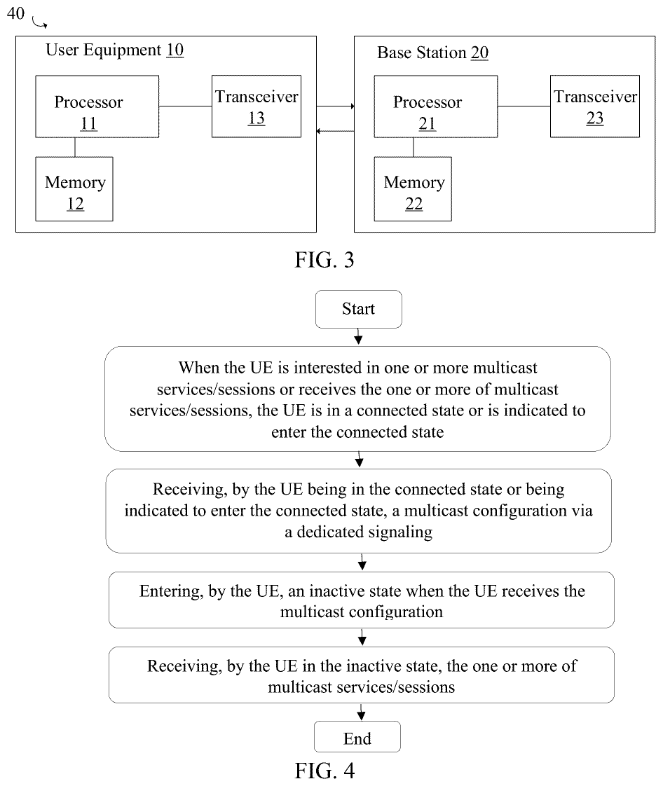

FIG. 3 illustrates that, in some embodiments, one or more user equipments (UEs) 10 and a base station (e.g., gNB) 20 for communication in a communication network system 40 according to an embodiment of the present disclosure are provided. The communication network system 40 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, when the UE 10 is interested in one or more multicast services/sessions or receives the one or more of multicast services/sessions, the UE 10 is in a connected state or is indicated to enter the connected state. The UE 10 being in the connected state or being indicated to enter the connected state receives a multicast configuration via a dedicated signaling. Further, the UE 10 enters an inactive state when the UE 10 receives the multicast configuration, and the UE 10 in the inactive state receives the one or more of multicast services/sessions.

FIG. 4 is a flowchart illustrating a wireless communication method for multicast/broadcast service (MBS) performed by a user equipment (UE) according to an embodiment of the present disclosure. In some embodiments, the wireless communication method for MBS performed by the UE includes: when the UE is interested in one or more multicast services/sessions or receives the one or more of multicast services/sessions, the UE is in a connected state or is indicated to enter the connected state, receiving, by the UE being in the connected state or being indicated to enter the connected state, a multicast configuration via a dedicated signaling, entering, by the UE, an inactive state when the UE receives the multicast configuration, and receiving, by the UE in the inactive state, the one or more of multicast services/sessions.

In some embodiments, the UE enters the inactive state if one or more of conditions are meet; or otherwise, the UE stays in the connected state, where the conditions comprise that: a requirement of quality of service (QOS) of the one or more of multicast services/sessions that the UE is interested or receives is lower than a first configured threshold; and a radio link quality of the UE is equal to or higher than a second configured threshold. In some embodiments, the one or more of conditions of whether the UE is allowed to enter the inactive state are constantly evaluated when the UE performs the wireless communication method for MBS.

In some embodiments, due to unicast reception by the UE, the UE is in the connected state or is indicated to enter the connected state when the UE is interested in the one or more multicast services/sessions or receives the one or more of multicast services/sessions. In some embodiments, the UE being in the connected state or being indicated to enter the connected state receives the multicast configuration and performs the unicast reception simultaneously. In some embodiments, if the UE is entitled to enter the inactive mode, the UE enters the inactive state when the UE receives the multicast configuration. In some embodiments, if one or more unicast services/sessions are finished by the UE and only one or more multicast services/sessions are ongoing, the UE is entitled to enter the inactive mode.

In some embodiments, the UE is indicated to enter the connected state comprising that when the UE being interested in the one or more multicast services/sessions or receiving the one or more of multicast services/sessions is in an idle/inactive state, the UE is indicated to enter the connected state, upon a reception of an indication transmitted by a base station due to the one or more multicast services/sessions start. In some embodiments, the indication is transmitted by a broadcast message. In some embodiments, when the UE enters the inactive mode, the multicast configuration is transmitted via an radio resource control (RRC) release message. In some embodiments, the RRC release message carries a suspend configuration, or the RRC release message carries a scheduling information of the multicast configuration. In some embodiments, the RRC release message carries the suspend configuration, after the UE receives the RRC release message carrying the suspend configuration, the UE enters the inactive state from the connect state. In some embodiments, the RRC release message carries the scheduling information of the multicast configuration, after the UE enters the inactive state, the UE receives the multicast configuration according to the scheduling information.

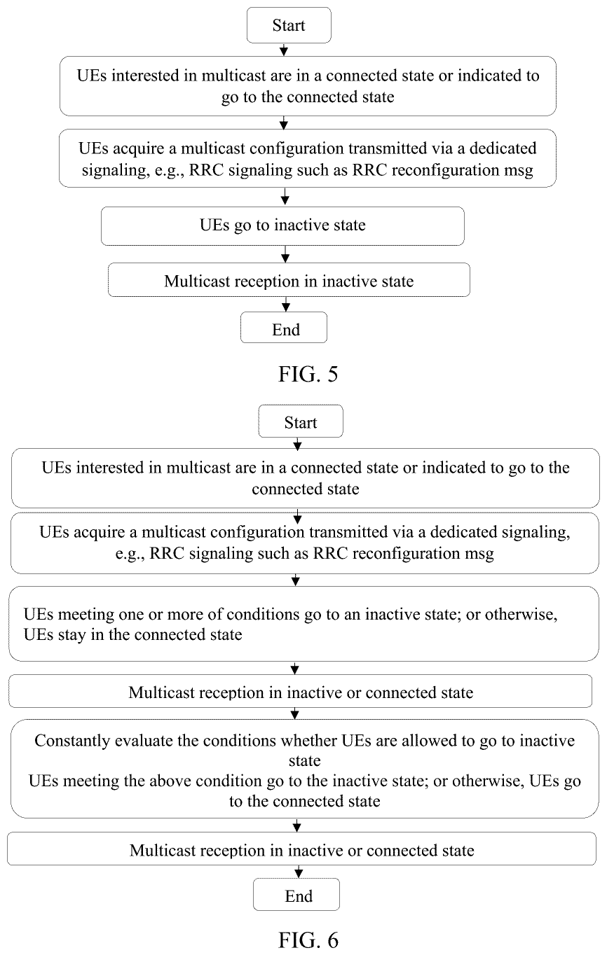

FIG. 5 to FIG. 10 illustrate examples regarding PTM configuration transmission transmitted in a connected state via a dedicated signaling.

FIG. 5 is a flowchart illustrating a wireless communication method for MBS according to an embodiment of the present disclosure. FIG. 5 illustrates that, in some embodiments, in a first step, UEs interested in multicast are in a connected state or indicated to go to a connected state. In a second step, UEs acquire a multicast configuration transmitted via a dedicated signaling, e.g., an RRC signaling such as an RRC reconfiguration message (msg). In a third step, UEs go to an inactive state. In a fourth step, multicast reception is performed by the UE in the inactive state. In summary, UEs interested in or receiving multicast service(s)/session(s) go to a connected state to receive a multicast configuration via a dedicated signaling, e.g., RRC signaling. Upon the multicast configuration reception, UEs go to an inactive state to receive the multicast service(s)/session(s).

FIG. 6 is a flowchart illustrating a wireless communication method for MBS according to an embodiment of the present disclosure. FIG. 6 illustrates that, in some embodiments, in a first step, UEs interested in multicast are in a connected state or indicated to go to a connected state. In a second step, UEs acquire a multicast configuration transmitted via a dedicated signaling, e.g., an RRC signaling such as an RRC reconfiguration message (msg). In a third step, UEs meeting one or more of the following conditions go to an inactive state; or otherwise, the UE stays in the connected state. The following conditions are the criteria of allowing UEs to go to the inactive state and include criterion 1 (or called condition 1) and/or criterion 2 (or called condition 2). In the criterion 1, the requirement of QOS of at least one of multicast services that the UE is interested in or receiving is lower than a configured threshold. In the criterion 2: a radio link quality of the UE is equal or higher than a configured threshold. The Criteria are configurable and can be condition 1 or 2 or both. In summary, UEs receiving the multicast configuration in the connected state should still stay in the connected state to receive multicast services in case the condition 1 and/or the condition 2 is met. Further, the conditions for UEs to go to the connected state are constantly evaluated.

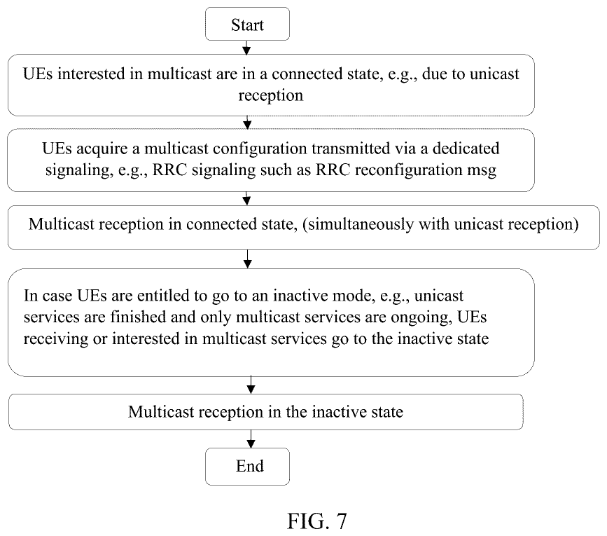

FIG. 7 is a flowchart illustrating a wireless communication method for MBS according to an embodiment of the present disclosure. FIG. 7 illustrates that, in some embodiments, in a first step, UEs interested in multicast are in a connected state or indicated to go to a connected state e.g., due to unicast reception. In a second step, UEs acquire a multicast configuration transmitted via a dedicated signaling, e.g., an RRC signaling such as an RRC reconfiguration message (msg). In a third step, UEs simultaneously perform the multicast reception and the unicast reception in the connected state. In a fourth step, in case UEs are entitled to go to inactive mode, e.g., unicast services are finished and only multicast services are ongoing, UEs receiving or interested in multicast services go to the inactive state. In a fifth step, UEs perform the multicast reception in the inactive state.

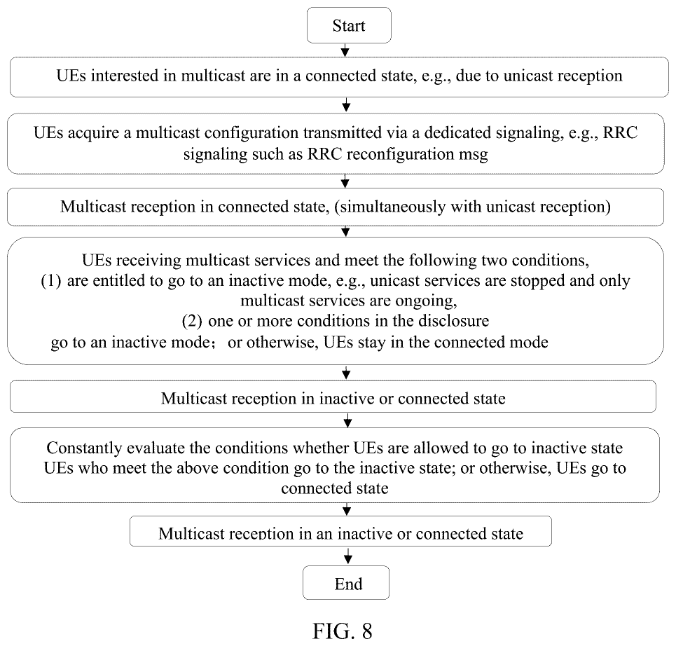

FIG. 8 is a flowchart illustrating a wireless communication method for MBS according to an embodiment of the present disclosure. FIG. 8 illustrates that, in some embodiments, in a first step, UEs interested in multicast are in a connected state or indicated to go to a connected state e.g., due to unicast reception. In a second step, UEs acquire a multicast configuration transmitted via a dedicated signaling, e.g., an RRC signaling such as an RRC reconfiguration message (msg). In a third step, UEs simultaneously perform the multicast reception and the unicast reception in the connected state. In a fourth step, UEs receiving multicast services and meet the following conditions go to the inactive mode, or otherwise, the UE stays in the connected state. (1) UEs are entitled to go to the inactive state, e.g., unicast services are stopped and only multicast services are ongoing, UEs receiving or interested in multicast services go to the inactive state. (2) UEs meeting one or more of the following conditions go to an inactive state; or otherwise, the UE stays in the connected state. The following conditions are the criteria of allowing UEs to go to the inactive state and include criterion 1 (or called condition 1) and/or criterion 2 (or called condition 2). In the criterion 1, the requirement of QOS of at least one of multicast services that the UE is interested in or receiving is lower than a configured threshold. In the criterion 2: a radio link quality of the UE is equal or higher than a configured threshold. The Criteria are configurable and can be condition 1 or 2 or both. In a fifth step, UEs perform the multicast reception in the inactive state or in the connected state. In a sixth step, UEs constantly evaluate the conditions whether UEs are allowed to go to the inactive state. That is, UEs meeting the above conditions go to the inactive state; or otherwise, UEs go to the connected state. In a seventh step, UEs perform the multicast reception in the inactive state or in the connected state.

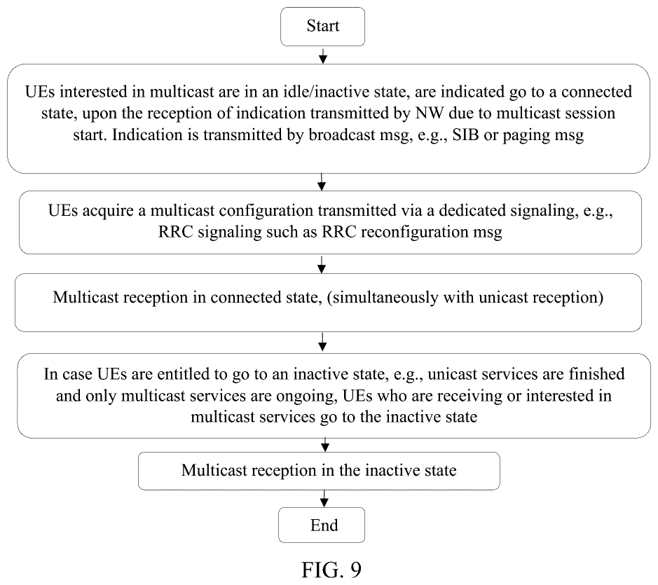

FIG. 9 is a flowchart illustrating a wireless communication method for MBS according to an embodiment of the present disclosure. FIG. 9 illustrates that, in some embodiments, in a first step, UEs interested in multicast are in an idle/inactive state, are indicated go to a connected state, upon the reception of an indication transmitted by a network such as a base station due to multicast services/sessions start. The indication is transmitted by a broadcast message (msg), e.g., a system information block (SIB), or a paging msg. In a second step, UEs acquire a multicast configuration transmitted via a dedicated signaling, e.g., an RRC signaling such as an RRC reconfiguration message (msg). In a third step, UEs simultaneously perform the multicast reception and the unicast reception in the connected state. In a fourth step, in case UEs are entitled to go to inactive mode, e.g., unicast services are finished and only multicast services are ongoing, UEs receiving or interested in multicast services go to the inactive state. In a fifth step, UEs perform the multicast reception in the inactive state.

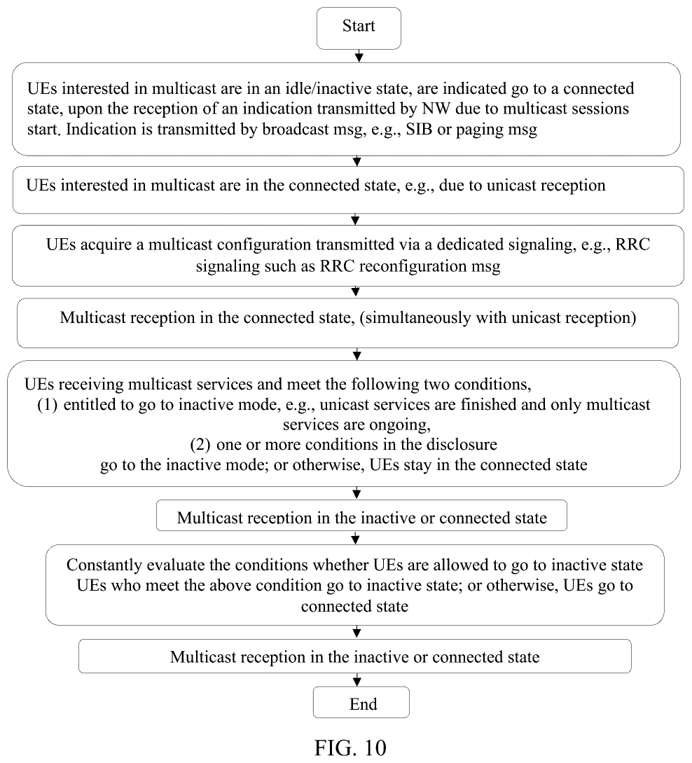

FIG. 10 is a flowchart illustrating a wireless communication method for MBS according to an embodiment of the present disclosure. FIG. 10 illustrates that, in some embodiments, in a first step, UEs interested in multicast are in an idle/inactive state, are indicated go to a connected state, upon the reception of an indication transmitted by a network such as a base station due to multicast services/sessions start. The indication is transmitted by a broadcast message (msg), e.g., a system information block (SIB), or a paging msg. In a second step, UEs interested in multicast are in a connected state or indicated to go to a connected state e.g., due to unicast reception. In a third step, UEs acquire a multicast configuration transmitted via a dedicated signaling, e.g., an RRC signaling such as an RRC reconfiguration message (msg). In a fourth step, UEs simultaneously perform the multicast reception and the unicast reception in the connected state. In a fifth step, UEs receiving multicast services and meet the following conditions go to the inactive mode, or otherwise, the UE stays in the connected state. (1) UEs are entitled to go to the inactive state, e.g., unicast services are stopped and only multicast services are ongoing, UEs receiving or interested in multicast services go to the inactive state. (2) UEs meeting one or more of the following conditions go to an inactive state; or otherwise, the UE stays in the connected state. The following conditions are the criteria of allowing UEs to go to the inactive state and include criterion 1 (or called condition 1) and/or criterion 2 (or called condition 2). In the criterion 1, the requirement of QOS of at least one of multicast services that the UE is interested in or receiving is lower than a configured threshold. In the criterion 2: a radio link quality of the UE is equal or higher than a configured threshold. The Criteria are configurable and can be condition 1 or 2 or both. In a sixth step, UEs perform the multicast reception in the inactive state or in the connected state. In a seventh step, UEs constantly evaluate the conditions whether UEs are allowed to go to the inactive state. That is, UEs meeting the above conditions go to the inactive state; or otherwise, UEs go to the connected state. In an eighth step, UEs perform the multicast reception in the inactive state or in the connected state.

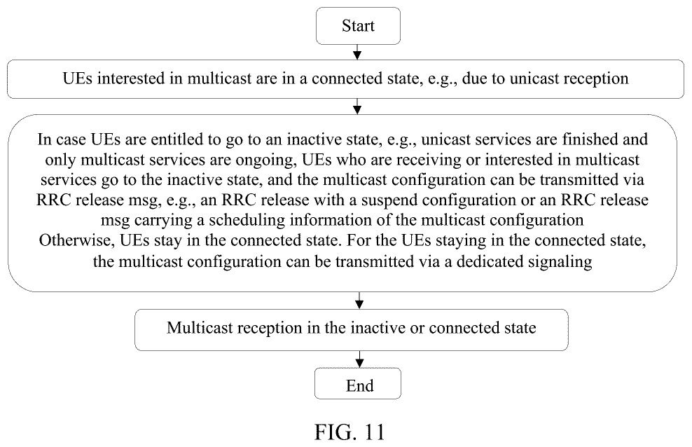

FIG. 11 to FIG. 14 illustrate examples regarding PTM configuration transmission transmitted in an inactive state. In some embodiments, the multicast configuration can be sent via an RRC release msg, e.g., an RRC release with a suspend configuration or an RRC release msg carrying a scheduling information of the multicast configuration. There two steps. In a first step, scheduling information of the multicast configuration is included in the RRC release msg. In a second step 2, after the reception of the RRC release, UEs go to the inactive state and receive the multicast configuration according to the scheduling information. Further, for UEs entitled to go to the inactive state, UEs go to the inactive state to receive multicast services/sessions. For UEs not able to go to the inactive state to receive multicast services/sessions (e.g., simultaneously with the unicast reception), the multicast configuration is sent by a dedicated signaling, and UEs stay in the connected state to receive multicast services/sessions. FIG. 11 to FIG. 14 illustrate that, in some embodiments, the multicast configuration can be delivered in two ways. The first way is that the multicast configuration is delivered via an RRC release msg (with suspend configuration). This message is the last message that the UE enters the inactive state from connected stated. After the UE receives this message, the UE enters the inactive state from the connect state. It can also be understood that the UE receives the multicast configuration when the is still in the connect state.

The second way is that the RRC release msg only carries a scheduling information of the multicast configuration. After the UE enters the inactive state, the UE receives the multicast configuration according to the scheduling information. It can also be understood that the UE is completely in the inactive state.

FIG. 11 is a flowchart illustrating a wireless communication method for MBS according to an embodiment of the present disclosure. FIG. 11 illustrates that, in some embodiments, in a first step, UEs interested in multicast are in a connected state or indicated to go to a connected state e.g., due to unicast reception. In a second step, in case UEs are entitled to go to the inactive mode, e.g., unicast services are finished and only multicast services are ongoing, UEs receiving or interested in multicast services go to inactive state. The multicast configuration can be transmitted via an RRC release msg, e.g., an RRC release with a suspend configuration or an RRC release msg carrying a scheduling information of the multicast configuration. Otherwise, UEs stay in the connected state. For the UEs staying in the connected state, the multicast configuration can be transmitted via a dedicated signaling. In a third step, UEs perform the multicast reception in the inactive state or in the connected state. In some embodiments, the multicast configuration can be delivered in two ways. The first way is that the multicast configuration is delivered via an RRC release msg (with suspend configuration). This message is the last message that the UE enters the inactive state from connected stated. After the UE receives this message, the UE enters the inactive state from the connect state. It can also be understood that the UE receives the multicast configuration when the is still in the connect state. The second way is that the RRC release msg only carries a scheduling information of the multicast configuration. After the UE enters the inactive state, the UE receives the multicast configuration according to the scheduling information. It can also be understood that the UE is completely in the inactive state.

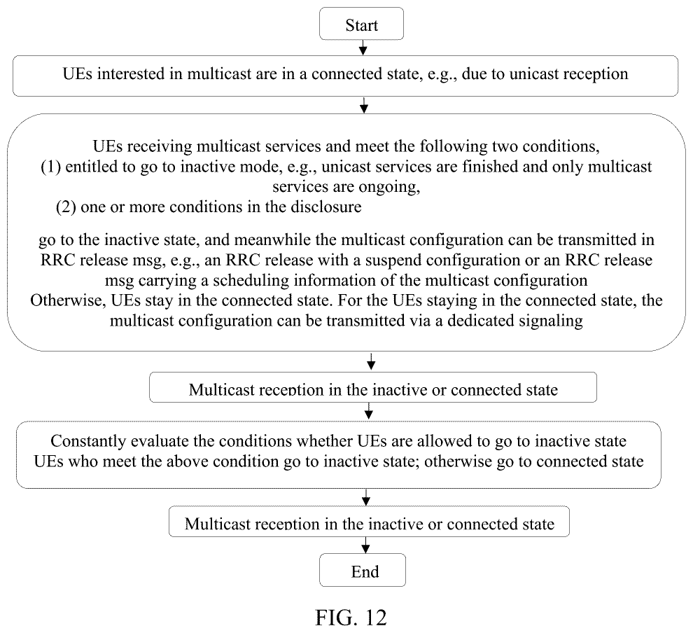

FIG. 12 is a flowchart illustrating a wireless communication method for MBS according to an embodiment of the present disclosure. FIG. 12 illustrates that, in some embodiments, in a first step, UEs interested in multicast are in a connected state or indicated to go to a connected state e.g., due to unicast reception. In a second step, UEs receiving multicast services and meet the following conditions go to the inactive mode and the multicast configuration can be transmitted via an RRC release msg, e.g., an RRC release with a suspend configuration or an RRC release msg carrying a scheduling information of the multicast configuration, or otherwise, the UE stays in the connected state. (1) UEs are entitled to go to the inactive state, e.g., unicast services are stopped and only multicast services are ongoing, UEs receiving or interested in multicast services go to the inactive state. (2) UEs meeting one or more of the following conditions go to an inactive state; or otherwise, the UE stays in the connected state and the multicast configuration can be transmitted via a dedicated signaling. The following conditions are the criteria of allowing UEs to go to the inactive state and include criterion 1 (or called condition 1) and/or criterion 2 (or called condition 2). In the criterion 1, the requirement of QOS of at least one of multicast services that the UE is interested in or receiving is lower than a configured threshold. In the criterion 2: a radio link quality of the UE is equal or higher than a configured threshold. The Criteria are configurable and can be condition 1 or 2 or both. In a third step, UEs perform the multicast reception in the inactive state or in the connected state. In a fourth step, UEs constantly evaluate the conditions whether UEs are allowed to go to the inactive state. That is, UEs meeting the above conditions go to the inactive state; or otherwise, UEs go to the connected state. In an fifth step, UEs perform the multicast reception in the inactive state or in the connected state. In some embodiments, the multicast configuration can be delivered in two ways. The first way is that the multicast configuration is delivered via an RRC release msg (with suspend configuration). This message is the last message that the UE enters the inactive state from connected stated. After the UE receives this message, the UE enters the inactive state from the connect state. It can also be understood that the UE receives the multicast configuration when the is still in the connect state. The second way is that the RRC release msg only carries a scheduling information of the multicast configuration. After the UE enters the inactive state, the UE receives the multicast configuration according to the scheduling information. It can also be understood that the UE is completely in the inactive state.

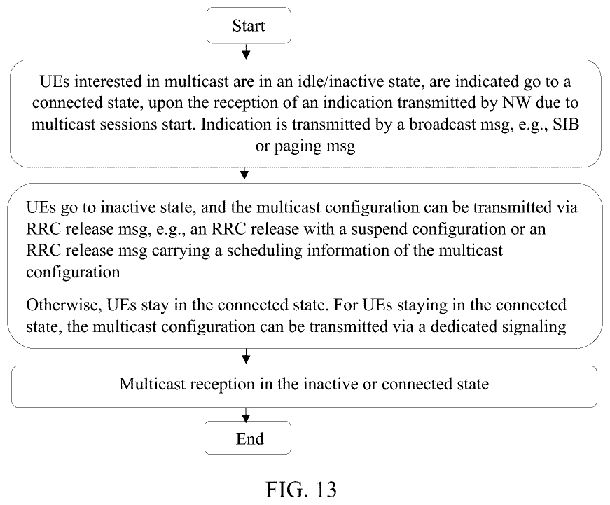

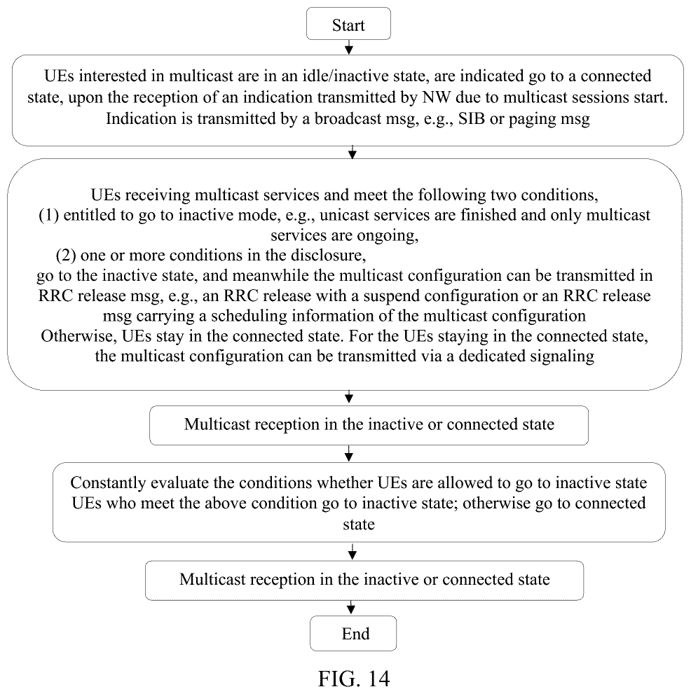

FIG. 13 and FIG. 14 illustrate that, in some embodiments, during the procedure that UEs from a connected state to an inactive state, a gNB can transmit a multicast configuration to UEs via an RRC release msg, e.g., an RRC release with a suspend indication. FIG. 13 and FIG. 14 also illustrate that, in some embodiments, in a first step, the scheduling information of multicast configuration is included in the RRC release msg. In a second step, after the reception of the RRC release, UEs go to the inactive state and receive the multicast configuration according to the scheduling information.

FIG. 13 is a flowchart illustrating a wireless communication method for MBS according to an embodiment of the present disclosure. FIG. 13 illustrates that, in some embodiments, in a first step, UEs interested in multicast are in an idle/inactive state, are indicated go to a connected state, upon the reception of an indication transmitted by a network such as a base station due to multicast services/sessions start. The indication is transmitted by a broadcast message (msg), e.g., a system information block (SIB), or a paging msg. In a second step, UEs go to the inactive state, and the multicast configuration can be transmitted via an RRC release msg, e.g., an RRC release with a suspend configuration or an RRC release msg carrying a scheduling information of the multicast configuration; or otherwise, UE stays in a connected state. For the UEs staying in connected state, the multicast configuration can be transmitted via a dedicated signaling. In a third step, UEs perform the multicast reception in the inactive or connected state. In some embodiments, the multicast configuration can be delivered in two ways. The first way is that the multicast configuration is delivered via an RRC release msg (with suspend configuration). This message is the last message that the UE enters the inactive state from connected stated. After the UE receives this message, the UE enters the inactive state from the connect state. It can also be understood that the UE receives the multicast configuration when the is still in the connect state. The second way is that the RRC release msg only carries a scheduling information of the multicast configuration. After the UE enters the inactive state, the UE receives the multicast configuration according to the scheduling information. It can also be understood that the UE is completely in the inactive state.

FIG. 14 is a flowchart illustrating a wireless communication method for MBS according to an embodiment of the present disclosure. FIG. 14 illustrates that, in some embodiments, in a first step, UEs interested in multicast are in an idle/inactive state, are indicated go to a connected state, upon the reception of an indication transmitted by a network such as a base station due to multicast services/sessions start. The indication is transmitted by a broadcast message (msg), e.g., a system information block (SIB), or a paging msg. In a second step, UEs receiving multicast services and meet the following conditions go to the inactive mode and the multicast configuration can be transmitted via an RRC release msg, e.g., an RRC release with a suspend configuration or an RRC release msg carrying a scheduling information of the multicast configuration, or otherwise, the UE stays in the connected state and the multicast configuration can be transmitted via a dedicated signaling. (1) UEs are entitled to go to the inactive state, e.g., unicast services are stopped and only multicast services are ongoing, UEs receiving or interested in multicast services go to the inactive state. (2) UEs meeting one or more of the following conditions go to an inactive state; or otherwise, the UE stays in the connected state and the multicast configuration can be transmitted via a dedicated signaling. The following conditions are the criteria of allowing UEs to go to the inactive state and include criterion 1 (or called condition 1) and/or criterion 2 (or called condition 2). In the criterion 1, the requirement of QOS of at least one of multicast services that the UE is interested in or receiving is lower than a configured threshold. In the criterion 2: a radio link quality of the UE is equal or higher than a configured threshold. The Criteria are configurable and can be condition 1 or 2 or both. In a third step, UEs perform the multicast reception in the inactive state or in the connected state. In a fourth step, UEs constantly evaluate the conditions whether UEs are allowed to go to the inactive state. That is, UEs meeting the above conditions go to the inactive state; or otherwise, UEs go to the connected state. In an fifth step, UEs perform the multicast reception in the inactive state or in the connected state. In some embodiments, the multicast configuration can be delivered in two ways. The first way is that the multicast configuration is delivered via an RRC release msg (with suspend configuration). This message is the last message that the UE enters the inactive state from connected stated. After the UE receives this message, the UE enters the inactive state from the connect state. It can also be understood that the UE receives the multicast configuration when the is still in the connect state. The second way is that the RRC release msg only carries a scheduling information of the multicast configuration. After the UE enters the inactive state, the UE receives the multicast configuration according to the scheduling information. It can also be understood that the UE is completely in the inactive state.

In summary, in some embodiments of the present disclosure, one or more of the following issues can be addressed. 1. Specify support of multicast reception by UEs in RRC_INACTIVE state [RAN2, RAN3]. 2. Specify PTM configuration for UEs receiving multicast in RRC_INACTIVE state [RAN2]. Therefore, in some embodiments of the present disclosure, multicast can be allowed to be received by UEs in an RRC connected mode and in an RRC inactive mode.

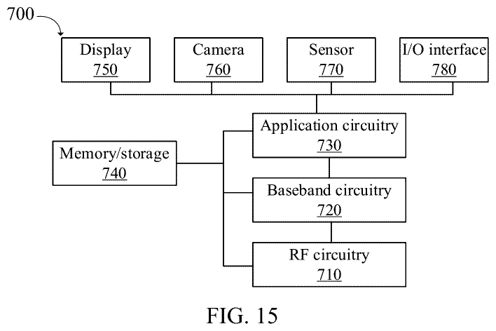

FIG. 15 is a block diagram of an example system 700 for wireless communication according to an embodiment of the present disclosure. Embodiments described herein may be implemented into the system using any suitably configured hardware and/or software. FIG. 15 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for multicast/broadcast service (MBS) performed by a user equipment (UE), comprising:
when the UE is interested in one or more multicast services/sessions or receives the one or more of multicast services/sessions, the UE is in a connected state or is indicated to enter the connected state;
receiving, by the UE being in the connected state or being indicated to enter the connected state, a dedicated signaling, wherein the dedicated signaling comprises a configuration for multicast reception in RRC_Inactive;
entering, by the UE, an inactive state when the UE receives the dedicated signaling; and
receiving, by the UE in the inactive state, the one or more of multicast services/sessions based on the configuration for multicast reception in RRC_Inactive.

2. The method according to claim 1, wherein the UE enters the inactive state if one or more of conditions are meet; or otherwise, the UE stays in the connected state, where the conditions comprise that:
a radio link quality of the UE is equal to or higher than a second configured threshold.

3. The method according to claim 1, wherein the one or more of conditions of whether the UE is allowed to enter the inactive state are constantly evaluated when the UE performs the wireless communication method for MBS.

4. The method according to claim 1, wherein due to unicast reception by the UE, the UE is in the connected state or is indicated to enter the connected state when the UE is interested in the one or more multicast services/sessions or receives the one or more of multicast services/sessions.

5. The method according to claim 1, wherein the UE being in the connected state or being indicated to enter the connected state receives the multicast configuration and performs the unicast reception simultaneously.

6. The method according to claim 1, wherein if the UE is entitled to enter the inactive mode, the UE enters the inactive state when the UE receives the multicast configuration.

7. The method according to claim 6, wherein if one or more unicast services/sessions are finished by the UE and only one or more multicast services/sessions are ongoing, the UE is entitled to enter the inactive mode.

8. The method according to claim 1, wherein the UE is indicated to enter the connected state comprising that when the UE being interested in the one or more multicast services/sessions or receiving the one or more of multicast services/sessions is in an idle/inactive state, the UE is indicated to enter the connected state, upon a reception of an indication transmitted by a base station due to the one or more multicast services/sessions start.

9. The method according to claim 8, wherein the indication is transmitted by a broadcast message.

10. The method according to claim 1, wherein when the UE enters the inactive mode, the multicast configuration is transmitted via a radio resource control (RRC) release message.

11. The method according to claims 10, wherein the RRC release message carries a suspend configuration, or the RRC release message carries a scheduling information of the multicast configuration.

12. The method according to claims 11, wherein the RRC release message carries the suspend configuration, after the UE receives the RRC release message carrying the suspend configuration, the UE enters the inactive state from the connect state.

13. The method according to claims 11, wherein the RRC release message carries the scheduling information of the multicast configuration, after the UE enters the inactive state, the UE receives the multicast configuration according to the scheduling information.

14. A user equipment (UE), comprising:
a memory;
a transceiver; and
a processor coupled to the memory and the transceiver;
wherein the processor is configured to execute a wireless communication method for multicast/broadcast service (MBS) comprising:
when the UE is interested in one or more multicast services/sessions or receives the one or more of multicast services/sessions, the UE is in a connected state or is indicated to enter the connected state;
receiving, by the UE being in the connected state or being indicated to enter the connected state, a dedicated signaling, wherein the dedicated signaling comprises a configuration for multicast reception in RRC_Inactive;
entering, by the UE, an inactive state when the UE receives the dedicated signaling; and
receiving, by the UE in the inactive state, the one or more of multicast services/sessions based on the configuration for multicast reception in RRC_Inactive.

15-19. (canceled)

20. The method according to claim 1, further comprising:
the UE going to the connected state in responsive to a radio link quality of the UE being lower than a configured threshold.

21. The UE according to claim 14, wherein the UE enters the inactive state if one or more of conditions are meet; or otherwise, the UE stays in the connected state, where the conditions comprise that:
a radio link quality of the UE is equal to or higher than a second configured threshold.

22. The UE according to claim 14, wherein:
the UE is configured to go to the connected state in responsive to a radio link quality of the UE being lower than a configured threshold.

23. The UE according to claim 14, wherein when the UE enters the inactive mode, the multicast configuration is transmitted via a radio resource control (RRC) release message.

24. The UE according to claims 23, wherein the RRC release message carries a suspend configuration, or the RRC release message carries a scheduling information of the multicast configuration.

25. The UE according to claims 24, wherein the RRC release message carries the suspend configuration, after the UE receives the RRC release message carrying the suspend configuration, the UE enters the inactive state from the connect state.
